(19) United States
(12) Patent Application Publication
(10) Pub. No.: US 2009/0053412 A1
(43) Pub. Date: Feb. 26, 2009

(54) Easy tear-off tape and method of making the same

(76) Inventor: Zhuliang Su, Jiaolian (CN)

Correspondence Address: KIRSCHSTEIN, OTTINGER, ISRAEL;& SCHIFFMILLER, P.C., 425 FIFTH AVENUE, 5TH FLOOR, NEW YORK, NY, 10016-2223, US

(21) Appl. No.: 11/894,168

(22) Filed: Aug. 20, 2007

(51) Int. Cl. B05D 5/10

(52) U.S. Cl. 427/208.4; 442/151

(57) ABSTRACT

A pressure-sensitive adhesive plastic tape can easily be manually torn, as from a supply roll, without the use of any tool. At least one lateral edge of the tape is beveled and inclined at an angle other than a right angle relative to the opposite major surfaces of the tape, thereby imparting a trapezoidal cross-section thereto.

### BACKGROUND OF THE INVENTION

So-called “friction tape” for covering otherwise exposed electrical conductors, especially at wire-to-wire connections, was made by impregnating a woven cloth material with a black, non-drying adhesive material. The tape was supplied in rolls from which a desired length of the tape was withdrawn for use and easily cut or simply torn off. If dispensers were used, they were more for convenience in holding a roll or rolls of tape than for severing the tape, because the tape was so easily torn.

Plastic film of various compositions were and are employed in place of the woven fabric in a myriad of applications, for example, the shipping industry in which cartons are taped closed before being transported. One or both surfaces of the plastic film were coated with a pressure-sensitive adhesive material. This plastic tape had the advantages of lower cost and higher mechanical strength as compared to friction tape.

However, a disadvantage of the pressure-sensitive adhesive, plastic tape was the greater difficulty of tearing a withdrawn portion of the tape due to its increased mechanical strength. Typically, the plastic tape was wound in a supply roll about a core and was mounted in a dispenser having some means, e.g., a cutting edge, for severing the withdrawn tape as required. The cutting edge, however, was usually exposed and constituted a safety risk.

Rolls of the plastic tape for electrical, mechanical and securing purposes were also supplied for use without a cutter or a dispenser, in which case a knife, scissors, or other tool had to be available at the moment being used to cut the plastic tape. Attempts to tear a piece of pressure-sensitive adhesive plastic tape, as had theretofore been done with friction tape, without a readily available tool, frequently meant only frustration. It was not uncommon for a person to resort to tearing the plastic tape with his or her own teeth when a cutting tool was not handy. Except when applied by an experienced person as a quick snap exerted at the very edge of the plastic tape, tensile forces tended only to stretch instead of ripping the plastic tape.

### SUMMARY OF THE INVENTION

One object of the present invention is to provide a pressure-sensitive adhesive plastic tape, which can be easily manually torn to separate a desired length for use from a supply roll. As used herein, the term “plastic tape” means a flexible strip of plastic carrier film having an essentially constant width and initially a length that is a large positive multiple of its width. he term “easy tear-off tape” means a tape that may be readily severed by manual manipulation without the use of any cutting tool.

More specifically, a tape of this kind is provided with opposite major surfaces and longitudinal lateral edges. A layer of a pressure-sensitive adhesive is coated on one of the major surfaces. At least one of the lateral edges is beveled and inclined at an angle other than a right angle relative to the major surfaces.

Preferably, both of the lateral edges are beveled and inclined at an angle other than a right angle relative to the major surfaces. The tape has a trapezoidal cross-section and a depth of non-uniform dimension. Both of the lateral edges diverge in a direction away from the one coated major surface. The tape is wound convolutely upon itself about a core to form a roll.

In order to tear the tape widthwise along a generally straight line at right angles to the lateral edges of the tape, a person grips the tape and subjects it to a ripping force applied at one of the lateral edges. Since the tape has its smallest cross-sectional dimension or depth at the site of the ripping force, the tear begins relatively easily. Once started, completion of the tear proceeds, again rather easily to the opposite edge.

The trapezoidal cross-section may be provided inexpensively by diverse means one of which is described hereinbelow by way of example.

In one aspect of the invention, a simple and inexpensive method of producing a roll of easily severable tape from a normal roll of normal pressure sensitive plastic adhesive tape is described. This may be done by positioning at least one cutter against the tape at an angle other than a right angle relative to the major surfaces of the tape, thereby beveling at least one of the lateral edges at an angle other than a right angle relative to the major surfaces. Preferably, two inclined cutters are used, thereby beveling each of the lateral edges at an angle other than a right angle and allowing the tape to be easily torn from either lateral edge thereof.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a side view of a pair of cutting blades in cutting contact with a roll of plastic tape for making the same in accordance with this invention;

FIG. 2 is an enlarged cross-sectional view of the plastic tape made in accordance with the method of FIG. 1; and

FIG. 3 is a view similar to that of FIG. 2 but showing a cross-sectional view of a typical prior art plastic tape.

### DETAILED DESCRIPTION OF THE PREFERRED EMBODIMENTS

One feature of the invention comprises the provision of beveling at least one of the lateral edges of a plastic tape, e.g., pressure-sensitive adhesive plastic tape, to permit the severing of the tape at a selected location at the beveled edge manually without the use of a tool of any kind. An exemplary method of beveling of the tape is shown and described.

At the outset, it is noted that the invention herein described is applicable to unreinforced plastic tape, that is, plastic film that is not provided with longitudinal filaments having sufficient strength in tension to substantially enhance the strength of the tape. The severing of such reinforced plastic tape requires cutting of the filaments. It should also be noted that the tape of the invention may be beveled either before or after the tape is rolled into its final product form.

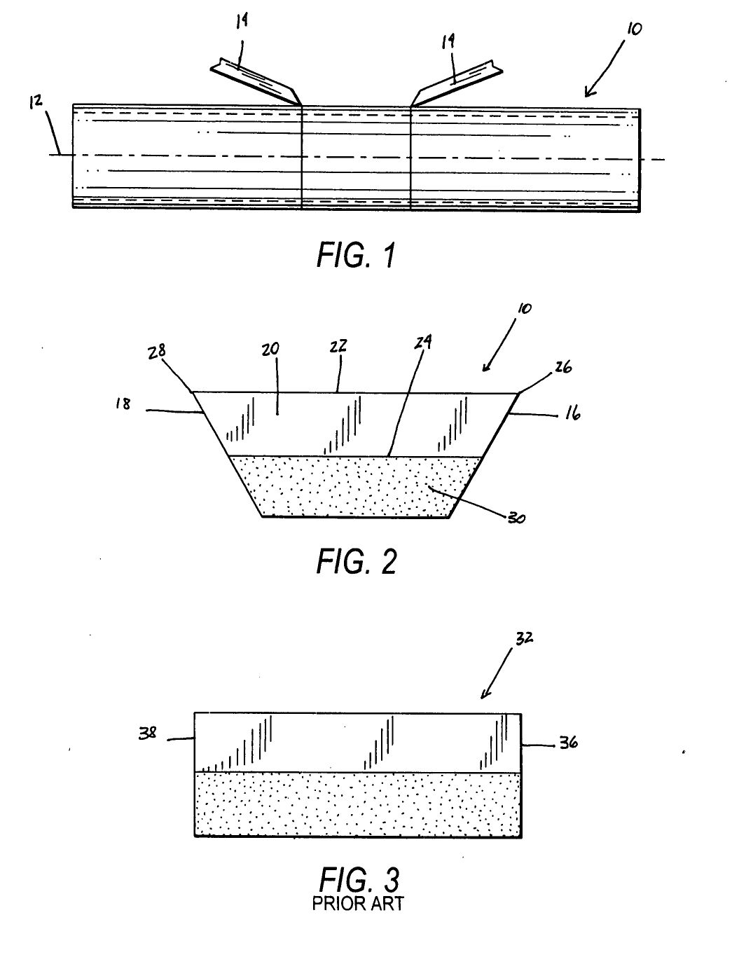

As shown in FIG. 1, a pressure-sensitive adhesive plastic tape 10 is spirally wound convolutely upon itself about an axis 12 into a supply roll and is brought into pressure engagement with at least one cutter 14, and preferably a pair of cutters 14, each cutter 14 being inclined relative to the axis 12. Preferably, the roll is rotated during the cutting operation so that the cutters form beveled lateral edges 16, 18, as shown in the enlarged cross-sectional view of FIG. 2.

More specifically, as shown in FIG. 2, the tape 10 includes a carrier film 20 having opposite major surfaces 22, 24 and the beveled lateral edges 16, 18. A layer of a pressure-sensitive adhesive 30 is coated on one of the major surfaces 24. At least one of the lateral edges 16, 18 is beveled and inclined at an angle other than a right angle relative to the major surfaces. This contrasts with the prior art tape 32 shown in the enlarged cross-sectional view of FIG. 3, in which the lateral edges 36, 38 are not beveled, but instead, are perpendicular to the major surfaces.

Preferably, both of the lateral edges 16, 18 are inclined at an angle other than a right angle relative to the major surfaces. The tape 10 has a trapezoidal cross-section and a depth of non-uniform dimension. This contrasts with the prior art tape 32 of FIG. 3 that has a rectangular cross-section and a depth of uniform dimension. Both of the lateral edges 16, 18 diverge in a direction away from the one coated major surface 24.

Plastic tape will rip and/or tear depending upon the composition of the particular plastic material and its thickness, and also upon the magnitude of the applied force and also the speed with which the force is brought to bear. The force at which the plastic tape will tear also depends upon the location of application of the tensile forces. A perpendicular lateral edge of plastic tape, as shown in the prior art tape of FIG. 3, resists rupture so that a piece of tape can be torn from a supply roll only with a snap application of very substantial force. This is something of a “trick” and most users must employ cutting means, and sometimes their own teeth, to detach a piece of tape from the supply roll of the prior art.

In order to tear the tape widthwise along a generally straight line at right angles to the lateral edges of the tape, a person grips the tape and subjects it to a ripping force applied at one of the beveled lateral edges at the points 26 or 28 at which the tensile force is concentrated. Since the tape has its smallest cross-sectional dimension or depth at the site of the points 26 or 28, the tear begins relatively easily for either right- or left-handed users. Once started, completion of the tear proceeds, again rather easily to the opposite edge of the tape.

The invention herein described solves the long standing and often vexing problem of severing a desired length of plastic tape, e.g., pressure-sensitive adhesive plastic tape, from a supply roll without the need of a knife or scissors. By a simple operation on a normal pressure-sensitive plastic tape or a roll thereof, the tape may be supplied to users in a form that is much more acceptable and satisfying to the users in that the tape may be easily torn from the supply roll using only the fingers and thumbs. This important advantage is attained without appreciably weakening or otherwise adversely affecting the quality of the tape.

It will be understood that each of the elements described above, or two or more together, also may find a useful application in other types of constructions differing from the types described above.

While the invention has been illustrated and described as embodied in an easy tear-off tape and method of making the same, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims:

1. A tearable tape, comprising:
a carrier film having opposite major surfaces and longitudinal lateral edges; and
a layer of a pressure-sensitive adhesive coated on one of the major surfaces,
at least one of the lateral edges being beveled and inclined at an angle other than a right angle relative to the major surfaces.

2. The tape of claim 1, wherein both of the lateral edges are beveled and inclined at an angle other than a right angle relative to the major surfaces.

3. The tape of claim 1, wherein the tape has a trapezoidal cross-section.

4. The tape of claim 1, wherein the tape has a depth of non-uniform dimension.

5. The tape of claim 1, wherein both of the lateral edges diverge in a direction away from the one major surface.

6. The tape of claim 1, wherein the film is wound convolutely upon itself about a core to form a roll.

7. The tape of claim 1, wherein the film is a plastic material.

8. A manually-tearable tape, comprising:
a carrier plastic film of trapezoidal cross-section and having opposite major surfaces and longitudinal lateral edges, at least one of the lateral edges being beveled and inclined at an angle other than a right angle relative to the major surfaces; and
a layer of a pressure-sensitive adhesive coated on one of the major surfaces.

9. A method of making a tearable tape, comprising the steps of:
coating a layer of a pressure-sensitive adhesive on one of two opposite major surfaces of a carrier film having longitudinal lateral edges; and
beveling at least one of the lateral edges at an angle other than a right angle relative to the major surfaces.

10. The method of claim 9, and beveling both of the lateral edges at an angle other than a right angle relative to the major surfaces.

11. The method of claim 9, and forming the tape with a trapezoidal cross-section.

12. The method of claim 9, and forming the tape with a depth of non-uniform dimension.

13. The method of claim 9, and diverging both of the lateral edges in a direction away from the one major surface.

14. The method of claim 9, and winding the film convolutely upon itself about a core to form a roll.

15. The method of claim 9, and forming the film of a plastic material.

16. The method of claim 9, wherein the forming step is performed by a cutter inclined at an angle other than a right angle relative to the other of the major surfaces.

17. The method of claim 9, wherein the forming step is performed by a pair of cutters each inclined at an angle other than a right angle relative to the other of the major surfaces.
